(19) United States
(12) Patent Application Publication
(10) Pub. No.: US 2006/0171380 A1
(43) Pub. Date: Aug. 3, 2006

(54) Method and system for integrated communications with access control list, automatic notification and telephony services

(76) Inventor: Kevin Mei Kwang Chia, Singapore (SG)

Correspondence Address: LAWRENCE Y.D. HO & ASSOCIATES PTE LTD, 30 BIDEFORD ROAD, #07-01, THONGSIA BUILDING, SINGAPORE, 229922, SG

(21) Appl. No.: 11/346,348

(22) Filed: Feb. 3, 2006

Related U.S. Application Data
(60) Provisional application No. 60/649,134, filed on Feb. 3, 2005.

(51) Int. Cl. H04L 12/66

(52) U.S. Cl. 370/352

(57) ABSTRACT

The present invention relates to a system and method that enable a variety of instant messaging client systems to interact each other either via internet-enabled devices or mobile WAP devices, governed by access control level. All the client systems connected to the instant messaging platform have mobile messaging services capability such as SMS and MMS to send out either text or multimedia message to another client via mobile network; coupled with the ability to initiate voice call using callback method. The present invention allows different client systems to have access to an integrated service combining various communication protocols ranging from wireless communications and automatic messaging to conventional wired communications. The integrated system of the present invention advantageously combines several servers for providing different databases for access by subscribers when logged into the integrated system. Various servers are further provided for implementing module specific tasks and services for supporting the various services delivered to the subscriber.

### FIELD OF THE INVENTION

The present invention generally relates systems and methods for electronic communications, and more particularly to a system and method that enables integrated communication with access control level, automatic notification (push) mobile messaging services, and voice call back capability using internet-enabled devices and mobile WAP devices through internet connection.

### BACKGROUND OF THE INVENTION

Increasingly, companies view immediate access to information as one way to maintain competitive advantages. To provide immediate access to the information, being connected to internet from personal computer or laptops is no longer enough. Mobile users need access with reasonable speed to their line-of-business applications and information on-the-go via various robust communication channel and media from anywhere and anytime by using any device.

A significant number of letters and telephone calls have been replaced by email messages. Although email is an effective communication medium, its application for ongoing on-line communications is hampered by the complex steps that are necessary to retrieve, view, reply, and send email messages. Further, email provides no way of knowing whether the addressee is on-line at that particular moment, nor is able to provide notification to the addressee upon the email arrival. By overcoming these deficiencies, instant messaging (“IM”) has gained great popularity over email to facilitate immediate and ongoing on-line communications.

Wireless and mobility have been the keywords for recent technology innovation, hence the increase in popularity of wireless communication is already on the way. People need to stay connected anywhere, anytime. Mobile and other intermittently-connected computing devices are quietly and swiftly becoming an essential part of corporate networks including the proliferation of instant messaging application. Subsequently mobile or wireless service providers have moved on to tap on the vast amount of information via Wireless Access Protocol (“WAP”), hence making the mobility of information a reality. In basic IM platform, it includes the ability for one user to immediately become aware of the presence of another user on the network. Combining IM platform with WAP connectivity provides mobile presence at “Anywhere-Anytime”. For instance, there is one occasion where User A connects using web browser and internet connectivity and User B hooks up using his WAP-enabled mobile phone; thus the signing by User A onto the IM platform gives indication to User B that User A is present on the network with certain predefined status. Once User B is aware of User A's presence on the network, User B can send instant messages to user A with a high level of confidence that User A will receive the messages in near real-time. In many cases, User A, though connected, may not be always in “Available” status. Using the same WAP connectivity, User A will also be immediately notified when he/she receives relevant information, for instance, emails from his/her contacts. This can be achieved using a notification alert agent or thin client that is installed and run on the mobile devices and/or personal computers. Such “push” technology is an integral part of the integrated messaging platform that brings different connectivity to the user.

However, the presence provided by the IM platform might not be always in a real sense, as a user might be away or not in front of his IM user interface. Therefore, there is a need to provide an integrated communication system and method with an integrated messaging and telephony platform that links between traditional on line IM users, and wireless WAP and mobile users with interactive messaging service and voice telephony callback. Hence a user will have various communication means coming together, including text-based and audible messaging, multimedia messaging, wireless automatic notification and voice telecommunication via call-back method.

### SUMMARY OF THE INVENTION

Therefore, one aspect of the present invention provides an integrated communication system that enables integrated interactivity among different networks including web or WAP infrastructure, mobile messaging network, and voice telephony system. the integrated communication system comprises at least one electronic device being able to perform at least one of the functions including email, message, on-line chat and phone; an integrated network including a mobile network, an Internet network, and a conventional phone network; wherein the integrated network provides integrated services to the at least one electronic device; and a group of backend servers that handle specific functions with interfaces and databases that are required for the proper operations of the integrated network.

In one embodiment of the integrated communication system, the at least one electronic device may be a WAP-enabled mobile phone, an online computer or laptop, or a conventional PSTN phone; wherein each electronic device is identified by a unique User ID and contact numbers.

In another embodiment of the integrated communication system, the mobile network interacts with the Internet network via a WAP gateway and a Messaging Gateway; and wherein the conventional phone network interacts with mobile network via a circuit switching gateway.

In yet another embodiment of the integrated communication system, the integrated services include email, messaging, on-line chat, and tele-conversation.

In still another embodiment of the integrated communication system, the group of the backend servers includes Instant Messaging (IM) interfaces, an IM Buddy List Database, a User ID database, Mobile Messaging Interfaces, a Contact Number Database, an Access Control List Database, a Callback Server, an IM Server, a File Server, a Push Messaging Server, a Database Server, and Notification Interfaces. In a further embodiment of the integrated communication system, the Instant Messaging interfaces handle various message formats and protocol conversions between Instant Messaging (hereby referred as “IM”) client and the IM server; the IM Server performs session management, population handling and management of the IM Buddy List Database belonging to a subscriber; the Buddy List Database is in turn managed in the User ID Database; the Database Server acts as the physical storage for storing persistent information about user profiles and transactions; the File server provides physical storage for storing user files; the Push Messaging server handles messaging engine processes and logs; the Mobile Messaging Interfaces handle conversions and message delivery management with multiple mobile messaging networks, including automatic email retrieval and notification; the Push Messaging Server will have direct connection with Push clients on mobile devices to deliver notification/alerts automatically when there are new emails; the Notification Interfaces serve as gateway for receiving and converting the information to be pushed out relevantly by push messaging server; and the Callback Server handles the circuit switching connection by providing method of calling both parties, one who requests the call and the other who receives the call, and then bridges the voice calls.

Another aspect of the present invention provides an integrated communication method for enabling a user to use integrated messaging services including emails, messaging, on-line chat, and tele-conversation. The integrated communication method comprises optionally registering for integrated messaging service by the user if the user is not a subscriber to an integrated communication system that affords the integrated messaging services; optionally offering invitations by the user to other users to become a member of its buddy list of the other users are not subscribers to the integrated communication system; optionally defining by the user and other users who have accepted the invitations an Access Control List (ACL) related to a specific contact group that may apply to a particular user; wherein every time the users login into the integrated communication system, the system shall retrieve ACL lists from both subscribers and apply the parameters accordingly; making choices of the type of communication from the integrated services afforded by the integrated communication system; wherein the type of communication may be on-line chat, email, messaging, and/or tele-conversation.

In one embodiment of the integrated communication method, the invitations can be in the form of email notification or Instant Messaging.

In another embodiment of the integrated communication method, in the step of offering invitations, if the invitation is not accepted, the user will try to resend its invitation to the user or send its invitation to another use who may be interested in joining its buddy list.

In yet another embodiment of the integrated communication method, in the step of making choices of the type of communication, the integrated communication system will first determine the presence or availability of Subscriber A to Subscriber B or vice versa; if either party is not available, the other subscriber has the option to leave message for his/her contact; if both parties are available for chat, the integrated communication system enables both parties to use other integrated services; if other integrated services are desired, the integrated communication system will enquire of the user whether he/she wants to send a SMS/MMS; if the user indicates that he/she has no interests in sending any message but desires to make a phone call, the integrated communication system will retrieve both users' contact numbers and make the voice call-back.

In a further embodiment of the integrated communication method, if the user desires to send a SMS/MMS, the integrated communication system will check whether the message is a text message (SMS) or multimedia message (MMS); if an 1-click option is used, then the integrated communication system proceeds to feed back the predefined content to a messaging interface module; if the 1-click option is not selected for sending a SMS message, the user has to compose his/her message and proceeds to send the composed message; if the 1-click option is not selected for multimedia messaging, then the integrated communication system launches a multimedia composing tool so that a MMS can be composed and sent.

In another further embodiment of the integrated communication method, if the user desires to make a voice call-back, the integrated communication system will initiate the voice call-back only if the ACL for both parties are allowed; when the voice call-back is being initiated, the integrated communication system first validates the contact numbers of both subscriber A and B; if both of the contact numbers are invalid then the voice call-back process will be terminated; if both of the contact numbers are valid, the integrated communication system will initiate the phone call to subscriber A as the requestor; then the integrated communication system will check whether the subscriber A answers the call; if the subscriber A does not answer the call, the integrated communication system will retry until the maximum configured times; if the subscriber A answers the call, the integrated system will then call the subscriber B, and check whether the subscriber B answers the call; if the subscriber B fails to answer the call, the integrated system will retry within the configured retry times; if the call attempt to subscriber B is successful, the integrated system will perform call switching to connect both parties and enable voice conversation to take place.

The objectives and advantages of the invention will become apparent from the following detailed description of preferred embodiments thereof in connection with the accompanying drawings.

### BRIEF DESCRIPTION OF THE DRAWINGS

Preferred embodiments according to the present invention will now be described with reference to the Figures, in which like reference numerals denote like elements.

FIG. 1 shows a block diagram illustrating of the integrated communication system in accordance with an embodiment of the present invention.

FIG. 2 lists some of the operations afforded by the integrated system of the present invention.

FIG. 3 shows a flow diagram illustrating of registering with and activating of the integrated communication system in accordance with one embodiment of the integrated communication method of the present invention.

FIG. 4 shows a detailed flow chart illustrating of making choices of integrated services in accordance with one embodiment of the integrated communication method of the present invention.

FIG. 5 shows a detailed flow chart illustrating of sending messages in accordance with one embodiment of the integrated communication method of the present invention.

FIG. 6 shows a detailed flow chart illustrating of making voice call-back in accordance with one embodiment of the integrated communication method of the present invention.

FIG. 7 shows a detailed flow chart illustrating of receiving notification in accordance with one embodiment of the integrated communication method of the present invention.

### DETAILED DESCRIPTION OF THE INVENTION

The present invention may be understood more readily by reference to the following detailed description of certain embodiments of the invention.

Throughout this application, where publications are referenced, the disclosures of these publications are hereby incorporated by reference, in their entireties, into this application in order to more fully describe the state of art to which this invention pertains.

In the following detailed description, specific details are set forth in order to provide a thorough understanding of the invention. However, it will be understood by those skilled in the relevant art that the present invention may be practiced without these specific details. In other instances, well-known methods, procedures, components, and materials have not been described in detail so as not to obscure the present invention.

As discussed above, the available electronic communications include emails, instant messaging (IM), on-line chat, and tele-conversation. However, any of them has its advantages and disadvantages; thus it would be desirable to have an integrated communication system that will provide comprehensive and interactive communications. For example, when User A is away from his desktop computer, User B can leverage on other media to reach User A. One of the services available is mobile messaging services such as Short Messaging Service (“SMS”) for text-based or Multimedia Messaging Service (“MMS”). The other is with integration of voice telephony call back capability, allowing users to be connected in real time via phone call.

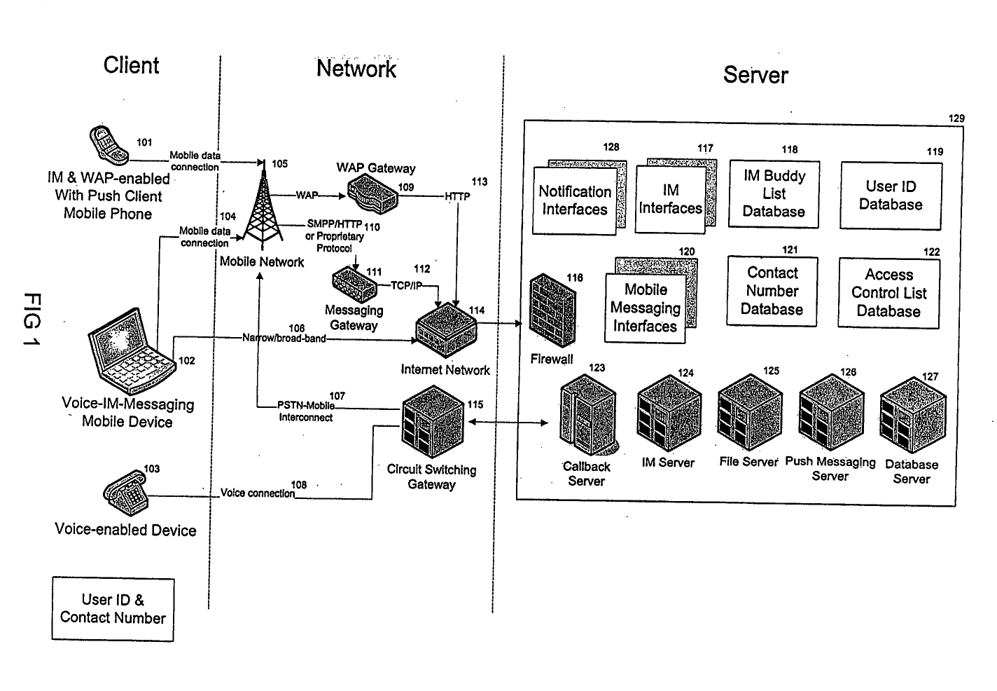

In one aspect of the present invention, there is provided an integrated communication system enabling integrated interactivity among different networks including web or WAP infrastructure, mobile messaging network, and voice telephony system. FIG. 1 shows a block diagram illustrating the integrated communication system in accordance with one embodiment of the present invention. As shown in FIG. 1, the integrated communication system comprises Clients, Networks, and Servers. The Clients here denote any electronic devices that can perform at least one of the functions including email, message, on-line chat and phone. It is apparent that some electronic devices can perform more than one or all of the functions. Thus, what a user of the electronic devices can do with the integrated communication system of the present invention solely depends on the electronic devices used. It is to be appreciated that the system will be described in terms of individual functions, devices and components, but the description in no means implies the configuration of the system unless it is explicitly stated herein.

Referring to FIG. 1, the Clients are illustrated with three commonly available electronic devices. The first one is the WAP-enabled mobile phone 101 that has data connectivity to mobile networks, and runs either Web/WAP-based Instant Messaging application or IM application specific to the mobile phone operating system. It also has voice exchange capability for telephony connection. The second one is an online computer 102 linked to the internet. With the present invention, it is to be appreciated that the online computers will have a more wide range of connectivity options such as narrow/broadband connection 106 with “voice over IP” call capabilities. However it might be less mobile due to its size (e.g., computer laptop or PDA). The third one is a conventional PSTN phone 103 basically representing voice-enabled device that operates alongside and complementing the WAP-enabled mobile phone 101 and the online computer 102. Each Client device will be identified by two components, a unique User ID assigned by the system and contact numbers associated with it.

Still referring to FIG. 1, the Networks are illustrated with the interactions of two sub-networks: the mobile network 105, and the Internet network 114. The Network further has a Circuit Switching Gateway 115. Now, there is provided a more detailed description of the interactions among the sub-networks and between the sub-networks and the Client devices. The mobile network 105 interacts with the Internet network 114 via a WAP Gateway 109 and a Messaging Gateway 111. For mobile messaging services, they are mainly divided into short messaging and multimedia messaging. Short messaging protocols include binary type Short Message Peer-to-Peer Protocol or proprietary text-based Hyper-Text Transport Protocol based delivery protocol (SMPP/HTTP) 110. The SMS Forum has recently released an XML variant of SMPP called Mobile Messaging Access Protocol (MMAP). It essentially provides a mechanism to package the SMPP commands as Simple Object Access Protocol (“SOAP”) messages and send them over SMS. Popular multimedia messaging protocol used is SOAP-based MM7 with HTTP bearer for connectivity between Multimedia Mobile Service Center (“MMSC”) and external mobile messaging application. The Messaging Gateway 111 will be the interface that employs both types of protocols to interconnect with various mobile networks, which in turn will be connected via TCP/IP-based protocol 112 and HTTP 113 to either Internet or managed data network 114. Circuit switching gateway 115 will be the bridge for voice connection 108 and PSTN-mobile interconnect 107 for delivering voice call service. The establishment of voice connection will be based on call back method, served by a Callback Server 123.

Still referring to FIG. 1, the Server 129 comprises a group of backend servers that handle specific functions with interfaces and database. The backend servers include Instant Messaging (IM) interfaces 117, an IM Buddy List Database 118, a User ID database 119, Mobile Messaging Interfaces 120, a Contact Number Database 121, an Access Control Level Database 122, a Callback Server 123, an IM Server 124, a File Server 125, a Push Messaging Server 126, a Database Server 127, and Notification Interfaces 128. Prior to brief description of each server, it is to be appreciated that all network connections between the backend servers and the Network will be through a firewall system 116 for providing security for the backend servers.

Instant Messaging interfaces 117 handle various message formats and protocol conversions between Instant Messaging (hereby referred as “IM”) client and the IM server 124. The IM Server 124 performs session management, population handling and management of the IM Buddy List Database 118 belonging to a subscriber. The Buddy List Database 118 is in turn managed in the User ID Database 119. The Database Server 127 acts as the physical storage for storing persistent information about user profiles and transactions. The File server 125 provides physical storage for storing user files.

The Push Messaging server 126 handles messaging engine processes and logs. On the other hand, the Mobile Messaging Interfaces 120 handle conversions and message delivery management with multiple mobile messaging networks, including automatic email retrieval and notification. The Push Messaging Server 126 will have direct connection with Push clients on mobile devices to deliver notification/alerts automatically when there are new emails. However, the Mobile Messaging Interfaces handle not only email notification but also other types of alert information that needs to be pushed to the client. Different types of information will be handled via the Notification Interfaces 128 that serve as gateway for receiving and converting the information to be pushed out relevantly by push messaging server.

The Callback Server 123 handles the circuit switching connection by providing method of calling both parties, one who requests the call and the other who receives the call, and then bridges the voice calls. In this case, the Callback Server 123 will maintain a Contact Number Database 121 in the system. All interactions among users in the integrated messaging platform are governed by a set of contact rules called Access Control List (hereby referred as “ACL”) Database 122. Base on these rules, the system will determine various activities including, but not limited to, checking on whether the users are viewable, contactable, and message-able, or whether the user allows the other party to call him/her.

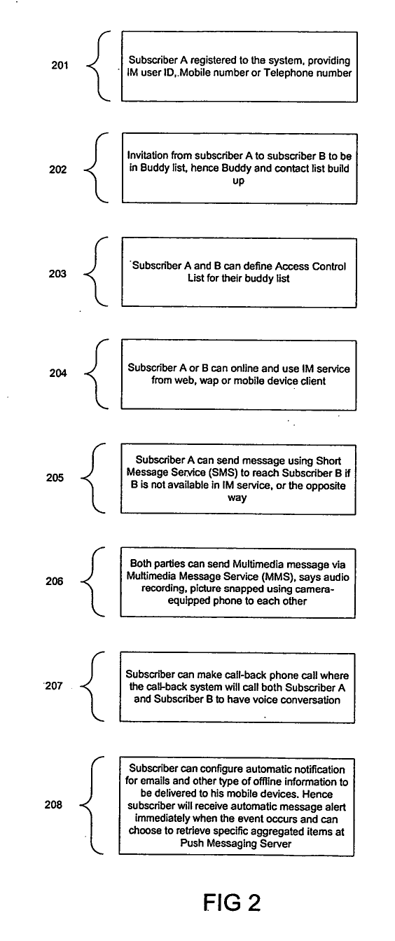

Now referring to FIG. 2, there is provided a list of main functions that can be performed by the integrated communication system. A subscriber of the integrated communication system will determine an ACL that governs the information access activities based on a buddy list's grouping. The integrated communication system allows a subscriber (hereby referred as “subscriber A”) to register to the system by providing its unique user ID and contact number(s) 201. This user ID may be assigned by the system with a predetermined format. After successful registration, the subscriber A may invite another subscriber (e.g., subscriber B) to join the buddy list 202. Then, the subscriber A further defines the ACL parameters that define Subscriber B's 203. The integrated communication system enables both subscribers to go online and use IM services from the web, WAP or mobile device client, governed by the ACL defined by each of them 204. During the IM sessions 205, 206, both subscribers can send messages using mobile messaging service such as short message or multimedia message, as long as the ACL rules permits. On top of that, both subscribers can make phone call to each other utilizing the callback system so as to have direct voice conversation 207. In the integrated communication system, the Push client configured in the mobile device will always run in the background, hence any notification that comes during the IM sessions will be notified immediately to the subscribers, one of the example notification will be any incoming emails 208.

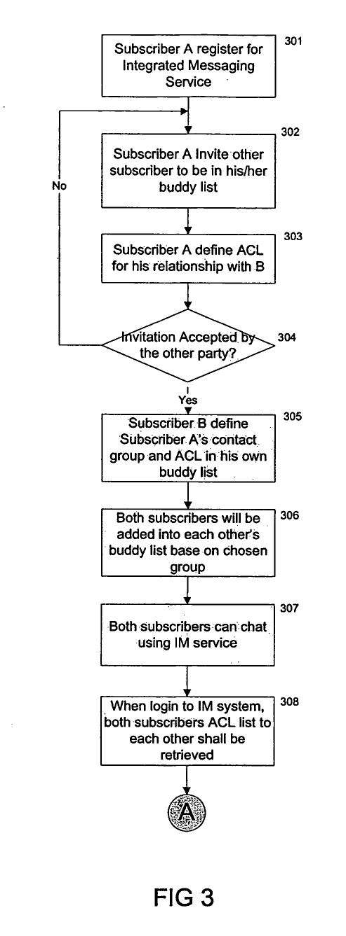

In another aspect of the present invention, there is provided a method for providing integrated communication. Now referring to FIG. 3, there is provided a detailed flow chart as an illustration of registering and activating the integrated communication system in accordance with one embodiment of the integrated communication method of the present invention. As a first step 301, a subscriber (“subscriber A) registers for Integrated Messaging Service provided by the integrated system of the present invention; then the subscriber A in step 302 offers invitations to other users to become a member of its buddy list. Those invitations can be in the form of email notification if the other user is not a subscriber of the system. If the other user is already a subscriber, the user is invited via Instant Messaging.

In step 303, the subscriber A may then define the ACL related to a specific contact group that may apply to a particular user, for example, a user may be in the “Friends” group whereby the group can see subscriber A online at all times and can send messages to A but cannot make phone call to A.

In the decision making step 304, if the invitation is not accepted, the subscriber A will try to resend its invitation to the user or send its invitation to another use who may be interested in joining its buddy list; if the invitation is accepted by the user (hereafter referred to as Subscriber B), then he/she will be added into the subscriber A's buddy list in the chosen group. By the same token, when Subscriber B accepts the invitation in step 305, Subscriber B can define the similar contact group and ACL relevantly for Subscriber A. Next in step 306, both subscribers will be added into each other's buddy list base on the chosen group. Upon the finish of the invitation process, both subscribers can now move on to use the IM service 307. In step 308, every time the subscribers login into the integrated system, the system shall retrieve ACL lists from both subscribers and apply the parameters accordingly.

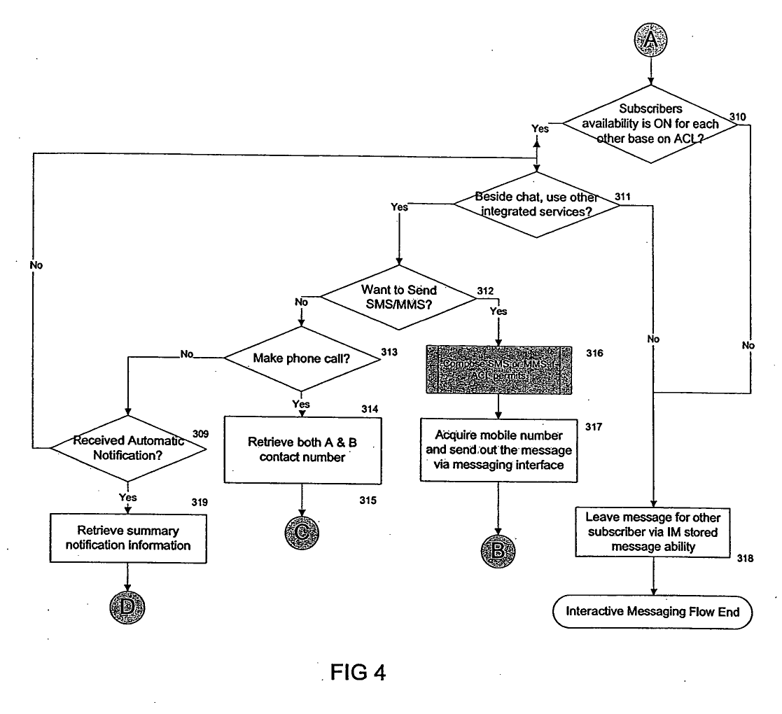

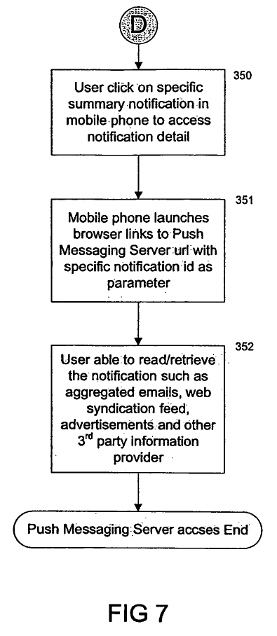

Now referring to FIG. 4, there is provided a detailed flow chart illustrating of one embodiment of the operation of making choices of integrated services afforded by the integrated system of the present invention. In the decision step 310, based on the ACL, the integrated system will determine the presence or availability of Subscriber A to Subscriber B or vice versa. If either party is not available, the other subscriber has the option to leave message for his/her contact, which will be handled by IM stored message capability in step 318. If both parties are available for chat, the integrated system enables both parties to use other integrated services 311. If no other integrated service is chosen, the integrated system will proceed to step 318 discussed above. If other integrated services are desired, the integrated system will enquire of the user whether he/she wants to send a SMS/MMS 312. If sending a message is desired, the integrated system will provide screens for the user to compose and send his/her message 316, 317; a more detailed description of sending the message will be provided hereinafter. If the user indicates that he/she has no interests in sending any message but desires to make a phone call 313, the integrated system will retrieve both users' contact numbers and make the voice call-back 314, 315; a more detailed description of making the voice call-back will be provided hereinafter. On step 309, subscriber will be notified automatically when there is new information, for instance, new email or new chat invitation. The notification will have summary or fragment of the information available for direct viewing on a mobile device, which can be acted upon to retrieve the complete or actual item represented by the notification itself. On step 319, user can access the detail information by accessing Push Messaging Server 126 that basically provide access to detail of the aggregated items by simply clicking on the specific notification 350 as shown in FIG. 7. Push client will automatically launches mobile phone browser and link direct to the specific notification URL address 351 in Push Messaging Server 126. These aggregated items 352 can be in form of emails, system messages, user messages and other 3^{rd} party information consolidation such as service alerts, advertisement, web syndication and so on. It is to be appreciated that while the operations has been described in a sequential manner it in no means denotes that the integrated services have to be operated in the described manner. In other words, the operation of the integrated services can be configured according to a user's preferences. For example, one user may prefer to have the option of making phone calls available first.

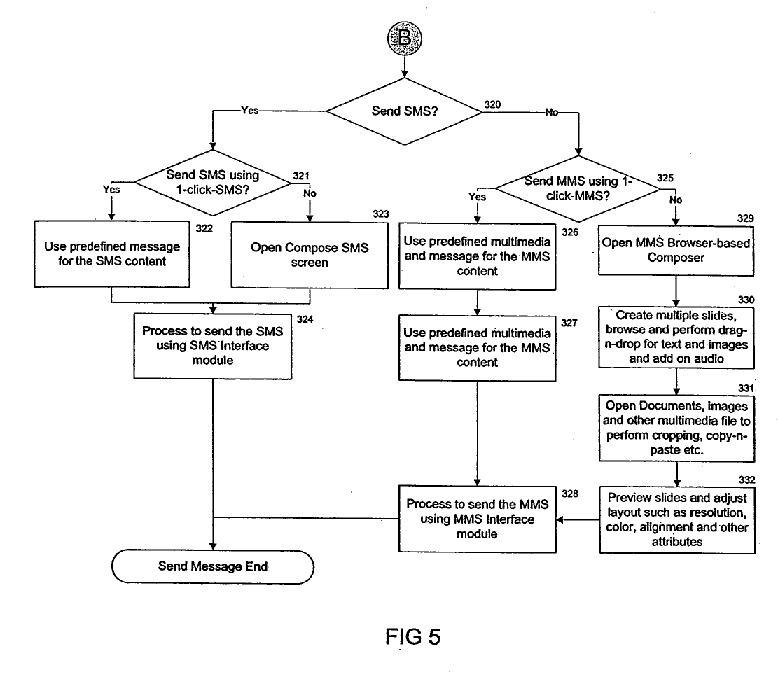

Now referring to FIG. 5, there is provided a detailed flow chart illustrating of one embodiment of the operation of sending messages enabled by the integrated system of the present invention. When the subscribers decide to send a message 317 as shown in FIG. 4, the integrated system will check whether the message is a text message (SMS) or multimedia message (MMS) 320. As shown in steps 321 and 325, the integrated system offers to both types of messages the 1-click option whereby there is predefined text content or multimedia content that is available for the subscribers depending on the situation at the time the subscribers are requesting the message sending. If the 1-click option is used, then the system proceeds to feed back the predefined content to the messaging interface module, in steps 322, 324 for short messaging and in step 326, 327, 328 for multimedia messaging. If the 1-click option is not selected for sending a SMS message, the user has to compose his/her message 323 enabled by the integrated system and proceeds to send the composed message 324. If the 1-click option is not selected for multimedia messaging, then the integrated system launches a multimedia composing tool in step 329. Multimedia files can be in multiple slides and each slide can have one or more of media such as text, images and audio as in step 330. These can all be done using a web browser and built in comprehensive drag-n-drop tools. Step 331 also shows that composing multimedia content can be achieved by retrieving content from existing documents or by image cropping. The composing tool also allows slides preview and layout adjustment, as in step 332. These adjustments can be in the form of resolution setting, color, alignment, duration and other multimedia attributes. Subscriber can save the composed multimedia component for future editing or sharing it with other subscriber or can simply send it over via multimedia messaging services. The browser-based composing tool provides rapid creation of multimedia from existing content easily via built-in browser which enables importing and converting various media formats into the common format that mobile phone is able to process. Then the composed MMS message will be sent using MMS interface module 328.

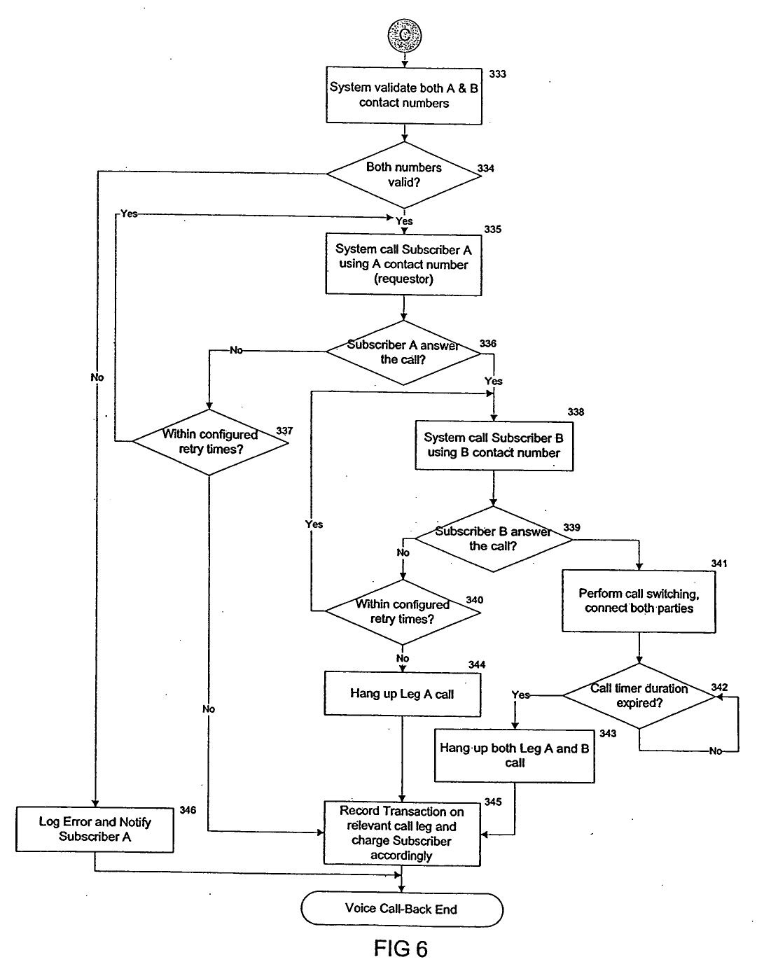

Now referring to FIG. 6, there is provided a detailed flow chart illustrating of one embodiment of the operation of making voice call-back enabled by the integrated system of the present invention. As shown in FIG. 4, the voice call-back is initiated only if the ACL for both parties are allowed 315. When the voice call-back is being initiated, the integrated system first validates the contact numbers of both the subscriber A and B 333. For the convenience of description, we take example of subscriber A calling subscriber B. In the decision step 334, if both of the contact numbers are invalid then the voice call-back process will be terminated; then an error log will be recorded, and the subscriber A will be notified accordingly 346. If both of the contact numbers are valid 334, the integrated system will initiate the phone call to subscriber A as the requestor 335. Then the integrated system will check whether the subscriber A answers the call 336. If the subscriber A does not answer the call for whatever reason, the integrated system will retry until the maximum configured times 337, and will record the transaction and notify subscriber A accordingly 345 if the subscriber A fails to answer at all. If the subscriber A answers the call, the integrated system will then call the subscriber B 338, and check whether the subscriber B answers the call 339. If the subscriber B fails to answer the call, the integrated system will retry within the configured retry times 340; if the call attempts to subscriber B is not successful upon the configured number of retries, the integrated system will then disconnect A's call connection 344 and proceed to step 345. If the call attempt to subscriber B is successful, the integrated system will perform call switching to connect both parties and enable voice conversation to take place 341. During the conversation, either party can hand up to terminate the call; the integrated system will proceed to step 345 (which is not shown in FIG. 6).

The integrated system may optionally set a timer to keep track of the call duration 342; once the timer is expired, the integrated system will terminate the conversation and hang up both call legs 343, and then proceed to step 345. The integrated system will finally record all relevant call legs information and perform charges to the subscribers according to the duration usage and status of the call 345. All failed calls will not be charged.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the spirit and scope of the present invention. Accordingly, the scope of the present invention is described by the appended claims and is supported by the foregoing description.

What is claimed is:

1. An integrated communication system enabling integrated interactivity among different networks including web or WAP infrastructure, mobile messaging network, and voice telephony system, the integrated communication system comprising:
at least one electronic device being able to perform at least one of the functions including email, message, on-line chat and phone;
an integrated network including a mobile network, an Internet network, and a conventional phone network; wherein the integrated network provides integrated services to the at least one electronic device; and
a group of backend servers that handle specific functions with interfaces and databases that are required for the proper operations of the integrated network.

2. The integrated communication system of claim 1, wherein the at least one electronic device may be a WAP-enabled mobile phone, an online computer or laptop, or a conventional PSTN phone; wherein each electronic device is identified by a unique User ID and contact numbers.

3. The integrated communication system of claim 1, wherein the mobile network interacts with the Internet network via a WAP gateway and a Messaging Gateway; and wherein the conventional phone network interacts with mobile network via a circuit switching gateway.

4. The integrated communication system of claim 1, wherein the integrated services include email, messaging, on-line chat, and tele-conversation.

5. The integrated communication system of claim 1, wherein the group of the backend servers include Instant Messaging (IM) interfaces, an IM Buddy List Database, a User ID database, Mobile Messaging Interfaces, a Contact Number Database, an Access Control List Database, a Callback Server, an IM Server, a File Server, a Push Messaging Server, a Database Server, and Notification Interfaces.

6. The integrated communication system of claim 5, wherein the Instant Messaging interfaces handle various message formats and protocol conversions between Instant Messaging (hereby referred as “IM”) client and the IM server; wherein the IM Server performs session management, population handling and management of the IM Buddy List Database belonging to a subscriber; wherein the Buddy List Database is in turn managed in the User ID Database; wherein the Database Server acts as the physical storage for storing persistent information about user profiles and transactions; wherein the File server provides physical storage for storing user files; wherein the Push Messaging server handles messaging engine processes and logs; wherein the Mobile Messaging Interfaces handle conversions and message delivery management with multiple mobile messaging networks, including automatic email retrieval and notification; wherein the Push Messaging Server will have direct connection with Push clients on mobile devices to deliver notification/alerts automatically when there are new emails; wherein the Notification Interfaces serve as gateway for receiving and converting the information to be pushed out relevantly by push messaging server; and wherein the Callback Server handles the circuit switching connection by providing method of calling both parties, one who requests the call and the other who receives the call, and then bridges the voice calls.

7. An integrated communication method for enabling a user to use integrated messaging services including emails, messaging, on-line chat, and tele-conversation, the integrated communication method comprising:
optionally registering for integrated messaging service by the user if the user is not a subscriber to an integrated communication system that affords the integrated messaging services;
optionally offering invitations by the user to other users to become a member of its buddy list of the other users are not subscribers to the integrated communication system;
optionally defining by the user and other users who have accepted the invitations an Access Control List (ACL) related to a specific contact group that may apply to a particular user; wherein every time the users login into the integrated communication system, the system shall retrieve ACL lists from both subscribers and apply the parameters accordingly;
making choices of the type of communication from the integrated services afforded by the integrated communication system; wherein the type of communication may be on-line chat, email, messaging, and/or tele-conversation.

8. The integrated communication method of claim 7, wherein the invitations can be in the form of email notification or Instant Messaging.

9. The integrated communication method of claim 7, wherein in the step of offering invitations, if the invitation is not accepted, the user will try to resend its invitation to the user or send its invitation to another use who may be interested in joining its buddy list.

10. The integrated communication method of claim 7, wherein in the step of making choices of the type of communication, the integrated communication system will first determine the presence or availability of Subscriber A to Subscriber B or vice versa; if either party is not available, the other subscriber has the option to leave message for his/her contact; if both parties are available for chat, the integrated communication system enables both parties to use other integrated services; if other integrated services are desired, the integrated communication system will enquire of the user whether he/she wants to send a SMS/MMS; if the user indicates that he/she has no interests in sending any message but desires to make a phone call, the integrated communication system will retrieve both users' contact numbers and make the voice call-back.

11. The integrated communication method of claim 10, wherein if the user desires to send a SMS/MMS, the integrated communication system will check whether the message is a text message (SMS) or multimedia message (MMS); if an 1-click option is used, then the integrated communication system proceeds to feed back the predefined content to a messaging interface module; if the 1-click option is not selected for sending a SMS message, the user has to compose his/her message and proceeds to send the composed message; if the 1-click option is not selected for multimedia messaging, then the integrated communication system launches a multimedia composing tool so that a MMS can be composed and sent.

12. The integrated communication method of claim 10, wherein if the user desires to make a voice call-back, the integrated communication system will initiate the voice call-back only if the ACL for both parties are allowed; when the voice call-back is being initiated, the integrated communication system first validates the contact numbers of both subscriber A and B; if both of the contact numbers are invalid then the voice call-back process will be terminated; if both of the contact numbers are valid, the integrated communication system will initiate the phone call to subscriber A as the requester; then the integrated communication system will check whether the subscriber A answers the call; if the subscriber A does not answer the call, the integrated communication system will retry until the maximum configured times; if the subscriber A answers the call, the integrated system will then call the subscriber B, and check whether the subscriber B answers the call; if the subscriber B fails to answer the call, the integrated system will retry within the configured retry times; if the call attempt to subscriber B is successful, the integrated system will perform call switching to connect both parties and enable voice conversation to take place.
